(19) United States
(12) Patent Application Publication
(10) Pub. No.: US 2010/0101809 A1
(43) Pub. Date: Apr. 29, 2010

(54) FIRE PROTECTION SYSTEM AND A METHOD FOR PROVIDING FIRE PROTECTION

(75) Inventor: Erik Christensen, Odense SOE (DK)

Correspondence Address: MCCORMICK, PAULDING & HUBER LLP, CITY PLACE II, 185 ASYLUM STREET, HARTFORD, CT, 06103, US

(73) Assignee: DANFOSS A/S, Nordborg (DK)

(21) Appl. No.: 12/524,997

(22) PCT Filed: Jan. 31, 2008
(86) PCT No.: PCT/DK2008/000044

§ 371 Date: Jan. 6, 2010

(30) Foreign Application Priority Data
Feb. 1, 2007 (DK) PA200700175

(51) Int. Cl. A62C 3/00

(52) U.S. Cl. 169/46; 169/65

(57) ABSTRACT

A fire protection system and method for providing a fire protection for a cooking unit (1) comprising a vessel (2) containing liquid fat or grease. The fire protection system comprises a fire suppressant source with water based fire suppressant, preferably essentially pure water. The fire protection system further comprises at least one pipe (4) being fluidly connected to the fire suppressant source in such a manner that fire suppressant from the fire suppressant source may be supplied to the pipe(s) (4). At least one pipe (4) is arranged above the vessel (2) and extending along a direction defined by a first rim (5) of the vessel (2), said pipe(s) (4) comprising a first set of nozzles (6a) directed towards the first rim (5) of the vessel (2), and a second set of nozzles (6b) directed towards a second rim (7) of the vessel (2), said second rim (7) being arranged opposite the first rim (5). Thereby the nozzles (6) are adapted to simultaneously spray fire suppressant supplied from the fire suppressant source towards the first and second rims (5, 7). Thereby the fire is contained in the vessel (2), and it is ensured that the vessel (2) is cooled, thereby preventing the fire from reigniting.

### CROSS REFERENCE TO RELATED APPLICATIONS

This application is entitled to the benefit of and incorporates by reference essential subject matter disclosed in International Patent Application No. PCT/DK2008/000044 filed on Jan. 31, 2008 and Danish Patent Application No. PA 2007 00 175 filed Feb. 1, 2007.

### FIELD OF THE INVENTION

The present invention relates to a fire protection system for a cooking unit and to a method for providing fire protection for a cooking unit. More particularly, the present invention relates to a fire protection system and a method for providing fire protection for a cooking unit of the kind comprising a vessel containing liquid fat or grease, e.g. large industrial oil fryers.

### BACKGROUND OF THE INVENTION

When oil fryers are used in cooking units it is known that the oil present in the fryer may get sufficiently hot to combust, thereby starting a fire. Normally, such fires should not be extinguished by means of water because this causes rapid formation of steam which may lead to splashing of burning oil or fat onto the surrounding area. Thereby large fireballs of burning vapour may spread the fire to the surrounding area with disastrous consequences.

Accordingly, a fire suppressant of a chemical nature is normally used for extinguishing fires of this kind. However, this has the disadvantage that the establishment where the cooking unit is installed will normally have to be completely closed down for a period following a fire in order to completely remove any trace of the chemical fire suppressant.

It is therefore desirable to be able to extinguish fires in cooking units comprising a vessel containing fat or grease by means of water. Various attempts have been made to achieve this. Thus, U.S. Pat. No. 6,173,791 discloses a method of extinguishing a fire in a fryer. The fryer comprises an upwardly presented liquid fat or grease zone. The method comprises the steps of locating a mist forming nozzle to direct mist toward the flames, delivering essentially pure water under pressure to the nozzle so that the nozzle forms a jet stream of water mist delivered from the nozzle as a rapid and expanding flow of concentrated mist, and directing said mist stream into the flames to substantially encompass the flames, and to flow toward the fat or grease zone, and for a sufficient time to extinguish the flames and to lower the temperature of the surface of the fat or grease zone to a level below combustion temperature. The step of directing the mist stream into the flames may be performed to effect rapid conversion of such mist to steam, which expands outwardly about the fat or grease zone, and rapidly blankets or hovers closely about that zone, blocking air or oxygen access to the fat or grease zone.

However, the fire protection system disclosed in U.S. Pat. No. 6,173,791 only offers limited control of the mist stream applied by the nozzle.

### SUMMARY OF THE INVENTION

It is, thus, an object of the invention to provide a water based fire protection system for a cooking unit, where it is possible to control the fire protection system in a more accurate manner than similar prior art fire protection systems.

It is a further object to provide a method for providing fire protection in a cooking unit in a manner which is more controlled than similar prior art methods, the method using a water based fire protection system.

According to a first aspect of the invention the above and other objects are fulfilled by providing a fire protection system for a cooking unit comprising a vessel containing liquid fat or grease, the fire protection system comprising:
a fire suppressant source comprising a propellant for propelling a water based fire suppressant from the fire suppressant source, and
at least one pipe being fluidly connected to the fire suppressant source in such a manner that fire suppressant from the fire suppressant source may be supplied to the pipe(s) by means of the propellant,
   wherein at least one pipe is arranged above the vessel and extending along a direction defined by a first rim of the vessel, said pipe(s) comprising a first set of nozzles directed towards the first rim of the vessel, and a second set of nozzles directed towards a second rim of the vessel, said second rim being arranged opposite the first rim, said nozzles thereby being adapted to simultaneously spray fire suppressant supplied from the fire suppressant source towards said first and second rims.

In the present context the term ‘fire protection system’ should be interpreted to mean a system which is capable of protecting the cooking unit, and preferably the immediate surroundings of the cooking unit, from damage due to fire. Preferably, the fire protection system is capable of extinguishing a fire in the case that a fire occurs. However, the fire protection system may alternatively or additionally be capable of obstructing a fire, e.g. by containing the fire, confining the fire to a specific position, i.e. preventing it from spreading, cooling the area of the fire, etc. Furthermore, the fire protection system may, alternatively or additionally, be capable of preventing the fire from reigniting after it has been extinguished.

The cooking unit is of the kind comprising a vessel containing liquid fat or grease. Thus, the cooking unit may be a fryer or the like containing liquid fat or grease used for frying food products. The vessel may preferably be of the kind having an open top through which the food products can be entered in and removed from the vessel. However, the vessel may alternatively be of a closed kind, e.g. having a lid which must be removed in order to gain access to the vessel. The cooking unit is preferably of the kind being used in large industrial kitchens, such as a large oil fryer. However, the fire protection system according to the present invention may also be applied in household fryers.

The fire suppressant source may be or comprise a container, e.g. a pressurized container, containing a suitable water based fire suppressant. Alternatively, the fire suppressant source may comprise a hook-up to an ordinary water supply, such as a tap. The water based fire suppressant may be propelled from the fire suppressant source in a various number of ways. This will be described in further detail below.

The fire protection system comprises at least one pipe being fluidly connected to the fire suppressant source. Accordingly, fire suppressant can be transferred from the fire suppressant source towards the cooking unit via the pipe(s).

At least one pipe is arranged above the vessel. This should be interpreted to mean that the pipe is positioned at a level which is above an uppermost part of the vessel. Furthermore, the pipe is preferably positioned directly above the vessel, i.e. at least part of the pipe is positioned within boundaries defined by outer walls of the vessel. In this case the pipe will face an upper surface of the liquid fat or grease, in particular if the vessel is of a kind having an open top.

Furthermore, the pipe extends along a direction defined by a first rim of the vessel. In the present context the term ‘rim’ should be interpreted to mean at least a part of an outer and upper boundary of the vessel and defined by outer walls of the vessel. In the case that the vessel has a substantially square or rectangular shape, the first rim could advantageously be one side of the square or rectangle. In this case the first rim is substantially rectilinear. It should, however, be noted that it could also be envisaged that the first rim has a curvilinear shape, depending of the design of the vessel. Since the pipe extends along a direction defined by the first rim, the pipe will follow a path corresponding to the shape of the first rim. Thus, in the case that the first rim has a substantially rectilinear shape, the pipe will follow a substantially rectilinear path, and in the case that the first rim has a curvilinear shape, the pipe will follow a curvilinear path. The pipe may be positioned immediately above the first rim, i.e. at a horizontal position corresponding to the horizontal position of the first rim. Alternatively, the pipe may be positioned horizontally distanced from the first rim, e.g. immediately above a centre part of the vessel.

The pipe(s) comprises a first set of nozzles directed towards the first rim of the vessel, and a second set of nozzles directed towards a second rim of the vessel. The second rim of the vessel is arranged opposite the first rim. Accordingly, the first rim and the second rim are positioned relatively to each other in such a manner that the liquid fat or grease is arranged between the first rim and the second rim. Thus, the nozzles are capable of spraying fire suppressant towards the first rim and towards the second rim simultaneously, and thereby fire suppressant is simultaneously directed towards opposing boundaries of the liquid fat or grease. Accordingly, a fire occurring in the liquid fat or grease will be confined to the vessel, and spreading of the fire to the surroundings is thereby prevented, or at least inhibited. Furthermore, by directing the fire suppressant towards the rims it is ensured that the outer walls of the vessel are cooled. During a fire the outer walls may become very hot, and this may lead to the fire reigniting because the hot vessel may cause the liquid fat or grease to combust. It is therefore a great advantage that the outer walls of the vessel are cooled, since the risk of the fire reigniting when fire suppressant is no longer supplied is thereby minimised.

It is also an advantage that a water based fire suppressant can be used, since this reduces cleaning requirements after extinguishing of the fire, as described above.

Thus, according to the present invention a fire protection system has been provided which in an efficient manner confines and extinguishes a fire in a vessel containing liquid fat or grease, using a water based fire suppressant, and which minimises the risk of the fire reigniting.

The fire protection system may further comprise at least a second pipe being fluidly connected to the fire suppressant source in such a manner that fire suppressant from the fire suppressant source may be supplied to the second pipe by means of the propellant, said second pipe being arranged above the vessel and extending along a direction defined by the second rim of the vessel, said second pipe comprising a first set of nozzles being directed towards the first rim of the vessel and a second set of nozzles being directed towards the second rim of the vessel. In this case the first pipe may advantageously be arranged directly above the first rim, and the second pipe may advantageously be arranged directly above the second rim.

The pipe(s) may be arranged in the interior of a hood arranged above the vessel. The hood may preferably be of the kind used for providing ventilation for the cooking unit, i.e. for exhausting cooking odour. Alternatively or additionally, the hood may be used for preventing splashing of liquid fat or grease during frying. The pipe(s) may be arranged along one or more outer rims of the hood, or at a central position of the hood.

The hood may be movable along an at least substantially vertical direction between a lower extreme position and an upper extreme position. In this case the first set of nozzles may preferably be directed towards the first rim of the vessel and the second set of nozzles may preferably be directed towards the second rim of the vessel when the hood is in the lower extreme position. According to this embodiment the hood may be adapted to prevent spraying of liquid fat or grease when it is in the lower extreme position, but it may be necessary to lift the hood in order to gain access to the vessel, e.g. in order to position or remove food products in/from the vessel. Thus, the hood is, in this case, preferably in the lower extreme position during normal operation, i.e. when food products are being fried in the vessel. Accordingly, the hood will be in this position most of the time. If it is not possible to ensure that the nozzles are always directed towards the first and second rim, respectively, regardless of the vertical position of the hood, it is appropriate to ensure that they are directed towards the rims most of the time, and at least during normal operation.

The fire protection system may further comprise additional nozzles, said additional nozzles being arranged at a level above the vessel and outside boundaries defined by the first rim and the second rim, said additional nozzles being directed towards the first rim and/or towards the second rim. According to this embodiment the nozzles which will normally be used in the case of a fire are preferably positioned directly above the vessel, while the additional nozzles are positioned next to the vessel in such a manner that they are able to spray fire suppressant towards the vessel in a substantially sideways direction. This embodiment is particularly advantageous in the case that the cooking unit comprises a conveyor which may be lowered to be submerged in the liquid fat or grease while carrying one or more food products. When food products are being positioned on the conveyor, the conveyor is lifted to a position above the upper surface of the liquid fat or grease. In the case that a fire occurs in the liquid fat or grease while the conveyor is in this position, the nozzles positioned directly above the vessel will not be able to direct fires suppressant towards the rims of the vessel because the conveyor will block the path. However, the additional nozzles will in this case be positioned in such a manner that they are capable of applying fire suppressant beneath the conveyor, and thereby towards the rims. Thereby it is ensured that a fire can also be extinguished in this situation.

The direction of the first set of nozzles and the direction of the second set of nozzles may define an angle there between, said angle being within the interval 20° to 45°, such as within the interval 25° to 40°, such as approximately 30°. It should, however, be noted that this angle depends on the vertical distance between the rims and the nozzles, as well as on the horizontal distance between the rims. The important issue is that the angle should be chosen in such a manner that the nozzles are directed towards the first rim and the second rim, respectively, as described above.

The nozzles may advantageously be of a kind which generates mist of water based fire suppressant. In the present context the term ‘mist’ should be interpreted to be droplets of water based fire suppressant, preferably substantially pure water, the droplets being very small, preferably having an average diameter which is smaller than 200 microns. According to this embodiment mist is directed towards the first rim and the second rim, respectively. This has the advantage that, due to the small size of the droplet, and to the expected high temperature of the liquid fat or grease and of the vessel, large amounts of vapour are quickly formed. The vapour will thereby confine the fire to within boundaries defined by the rims of the vessel, thereby preventing splashing of burning fat or grease and preventing oxygen from being supplied to the fire. Accordingly, the fire is prevented from spreading to the surroundings, and at the same time the fire is quenched due to lack of oxygen.

The nozzles belonging to the first set of nozzles and/or the nozzles belonging to the second set of nozzles may be distributed at least substantially equidistantly along the direction defined by the first rim of the vessel. Thereby an at least substantially uniform distribution of fire suppressant is ensured along the direction defined by the first rim.

The nozzles belonging to the first set of nozzles may have a flow capacity which differs from a flow capacity of nozzles belonging to the second set of nozzles. In the case that the nozzles are positioned directly above one of the rims, the distance from the nozzles to this rim will be shorter than the distance from the nozzles to the other rim. Accordingly, nozzles having a larger flow capacity may be applied for directing fire suppressant towards the rim at the longest distance from the nozzles.

Alternatively or additionally, nozzles having a larger flow capacity than the remaining nozzles may be arranged at or near end parts of the vessel. This is particularly useful in the case that the vessel has a substantially square or rectangular shape and nozzles are only arranged along a direction defined by one of the rims and not along a direction transversely thereto. In this case nozzles at or near an end part of the vessel have to cover the end part, and it may therefore be desirable to apply nozzles having an increased flow capacity in these positions.

The fire protection system may be automatically operable. In this case the fire protection system may further comprise one or more sensors adapted to detect one or more relevant fire parameters, and the fire protection system may be operable in response to one or more signals generated by the one or more sensors. According to this embodiment the fire protection system will automatically start operation in the case that a fire occurs, and one or more relevant fire parameters is/are therefore detected. Relevant fire parameters could include, but are not limited to, a set temperature.

Alternatively or additionally, the fire protection system may be manually operable, i.e. a person may manually activate the fire protection system in the case that he or she notices that a fire has started in the cooking unit. This may, e.g., be achieved by means of a push button, a handle, or any other suitable operating means.

The propellant may be or comprise a nitrogen propellant. In this case nitrogen is preferably kept under pressure in a first cylinder, while water based fire suppressant is contained in a second cylinder. The first and the second cylinder are connected in such a manner that the pressurized nitrogen provides pressure to the water based fire suppressant, thereby driving it into the at least one pipe.

As an alternative any other suitable pressurized gas may be used as a propellant in stead of nitrogen. As another alternative, the propellant may be pressure applied to the water based fire suppressant, e.g. by means of a pump, preferably a high pressure pump.

The water based fire suppressant may advantageously be water, such as at least substantially pure water. This has the advantage that no hazardous chemicals will be present in or near the cooking unit after the fire has been extinguished, and the cleaning task afterwards is thereby minimised as described above.

According to one embodiment, each of the nozzles of the fire protection system may be subjected to at least substantially identical pressure of fire suppressant from the fire suppressant source. This has the advantage that there are fewer parts in fire protection systems because there is no need for extra pressure reducing valves and extra pipe(s) to supply the water based fire suppressant to the nozzles with different pressure. When having fewer parts the fire protection system becomes cheaper and more reliable.

According to a second aspect of the invention the above and other objects are fulfilled by providing a method of providing fire protection for a cooking unit comprising a vessel containing liquid fat or grease, the method comprising the steps of:
providing a fire suppressant source,
providing at least one pipe comprising a plurality of nozzles,
fluidly connecting the fire suppressant source and the at least one pipe,
propelling a water based fire suppressant from the fire suppressant source to each of the plurality of nozzles, via the at least one pipe, and
directing the nozzles in such a manner that a varying density of water based fire suppressant is obtained along an at least substantially transversal direction of the vessel.

It should be noted that a skilled person would readily recognise that any feature described in combination with the first aspect of the invention could equally be combined with the second aspect of the invention, and vice versa. Thus, the method according to the second aspect may advantageously be performed using a fire protection system according to the first aspect of the invention.

It is an advantage that the nozzles are directed in such a manner that a varying density of water based fire suppressant is obtained along an at least substantially transversal direction of the vessel, since it is thereby possible to design the density distribution in such a manner that an optimal fire protection is obtained under the given circumstances.

The vessel may comprise a first rim and a second rim, said rims defining boundaries of the vessel along the at least substantially transversal direction, and the step of directing the nozzles may be performed in such a manner that local maxima of the density distribution are obtained at or near the rims. According to this embodiment the density distribution is designed in such a manner that high densities are obtained in areas at and near the first and second rims, while a somewhat lower density is obtained at a centre part of the vessel. Thereby the fire may be contained in the vessel, i.e. it may be prevented from spreading to the surroundings. This has already been described with reference to the first aspect of the invention.

The step of directing the nozzles may comprise directing a first set of nozzles towards the first rim and directing a second set of nozzles towards the second rim. This has also been described above with reference to the first aspect of the invention.

### BRIEF DESCRIPTION OF THE DRAWINGS

The invention will now be described in further detail with reference to the accompanying drawings in which

FIG. 1 is a perspective view of a cooking unit having a fire protection system according to a first embodiment of the invention installed therein,

FIG. 2 is a perspective view of a part of the fire protection system installed in the cooking unit of FIG. 1,

FIG. 3 is an end view of the part shown in FIG. 2,

FIG. 4 is a side view of the cooking unit of FIG. 1,

FIG. 5 is a perspective view of a cooking unit having a fire protection system according to a second embodiment of the invention installed therein, and

FIG. 6 is a side view of the cooking unit of FIG. 5.

### DETAILED DESCRIPTION OF THE PREFERRED EMBODIMENTS

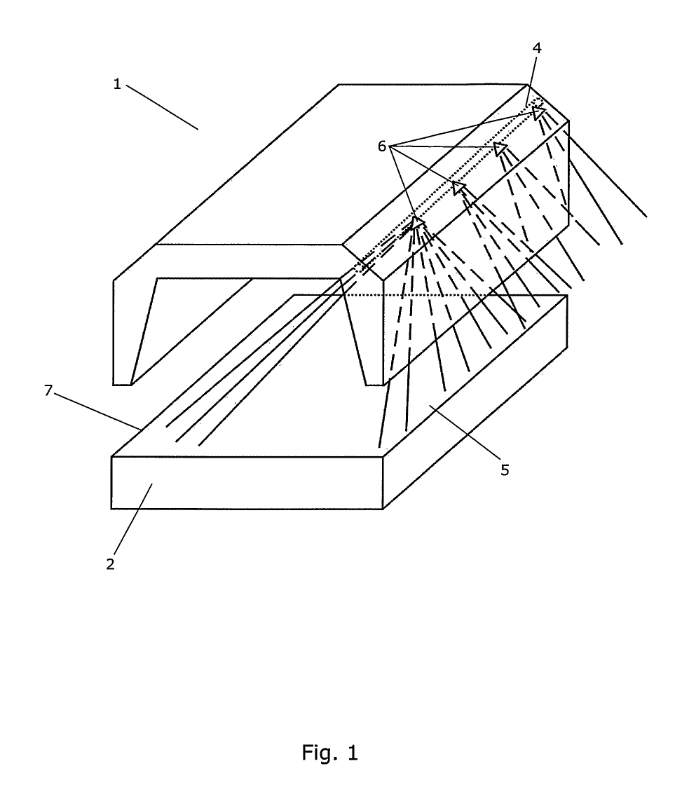

FIG. 1 is a perspective view of a cooking unit 1. The cooking unit 1 comprises a vessel 2 which contains liquid fat or grease, and which is open in an upwards direction. The cooking unit 1 further comprises a hood 3 arranged above the vessel 2. The hood 3 may be of a kind which is movable in a substantially vertical direction, in such a manner that it may be lifted to allow access to the vessel 2 and may be lowered to substantially close against the vessel 2. The hood 3 will, in this case, normally be in the lowered position during normal operation, i.e. when food is being cooked in the vessel 2. Alternatively, the hood 3 may be of a kind which is not movable, i.e. it is substantially fixed at a certain vertical level.

At an interior part of the hood 3 a pipe 4 is arranged in such a manner that it is arranged above a first rim 5 of the vessel 2 at a position corresponding to the position of the first rim 5, and extends substantially along the full length of the vessel 2. The pipe 4 is fluidly connected to a fire suppressant source (not shown), the fire suppressant being water based, preferably at least substantially pure water. The pipe 4 is provided with a number of nozzles 6 arranged in such a manner that some nozzles 6 are adapted to direct fire suppressant towards the first rim 5 of the vessel 2 and other nozzles 6 are adapted to direct fire suppressant towards a second rim 7 of the vessel 2, the second rim 7 being arranged opposite and substantially parallel to the first rim 5.

Thus, in the case of a fire in the liquid fat or grease contained in the vessel 2 the fire protection system is activated, either automatically or manually, thereby causing fire suppressant to be delivered from the nozzles 6 of the pipe 4. Accordingly, fire suppressant will be directed towards the first rim 5 and towards the second rim 7, and a density distribution of fire suppressant is thereby obtained defining high densities at or near the rims 5, 7 and a lower density near the middle of the vessel 2. This density distribution ensures that the fire is contained within the rims 5, 7, i.e. within the vessel 2. Furthermore, splashing of the burning fat or grease is prevented due to the higher density of fire suppressant along the rims 5, 7.

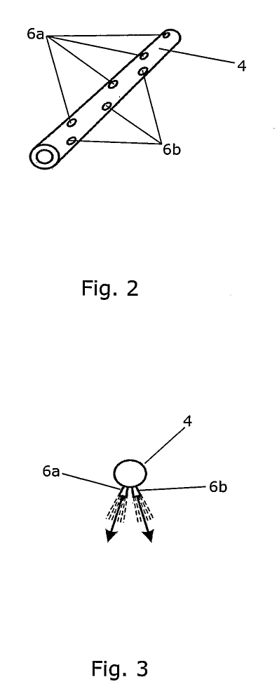

FIG. 2 is a perspective view of the pipe 4 arranged at the interior part of the hood 3 of the cooking unit 1 of FIG. 1. It is clear from FIG. 2 that the pipe 4 is hollow and thereby capable of supplying fire suppressant to the nozzles 6. It is also clear from FIG. 2 that the nozzles 6 are divided into two set of nozzles 6, one set of nozzles 6a being adapted to be directed towards the first rim 5 when the pipe 4 is installed under the hood 3, and another set of nozzles 6b being adapted to be directed towards the second rim 7.

FIG. 3 is a side view of the pipe 4 shown in FIG. 2. FIG. 3 illustrates the mutual positions of the nozzles 6a, 6b. In the embodiment shown in FIG. 3 the nozzles 6a, 6b are arranged with an angle of approximately 30° there between. It is clear that this mutual angle and the shapes of the nozzles 6a, 6b result in high densities of fire suppressant in the directions defined by the nozzles 6a, 6b and a relatively low density of fire suppressant between these directions.

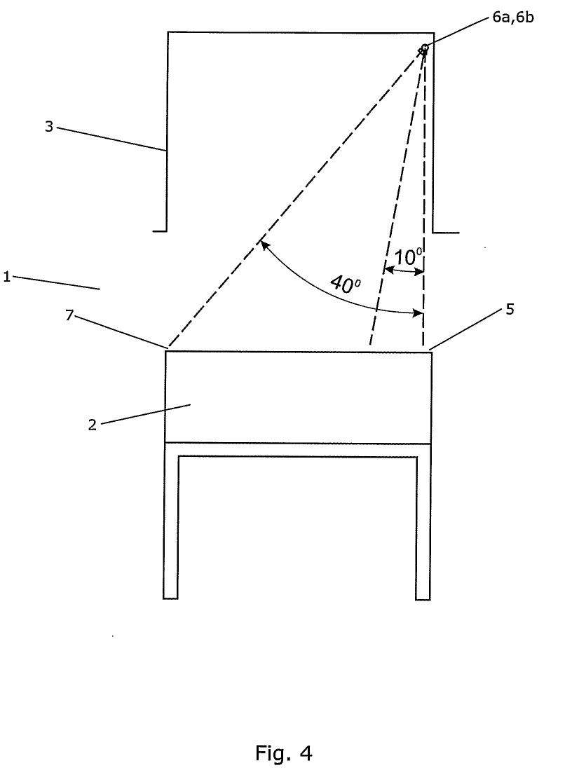

FIG. 4 is a side view of the cooking unit 1 of FIG. 1. It is clear from FIG. 4 that the nozzles 6a, 6b are positioned substantially directly above the first rim 5. FIG. 4 illustrates that first nozzles 6a are adapted to direct fire suppressant in a direction which is approximately 10° with respect to a vertical line pointing directly towards the first rim 5, and second nozzles 6b are adapted to direct fire suppressant in a direction which is approximately 40° with respect to the vertical line. The angle of 40° results in the fire suppressant being directed towards the second rim 7. It should be noted that the directions indicated in FIG. 4 are mean directions, and that the nozzles 6a, 6b will supply a diverted beam of fire suppressant about this mean direction. Accordingly, the angle of 10° will in fact result in fire suppressant being directed towards the first rim 5.

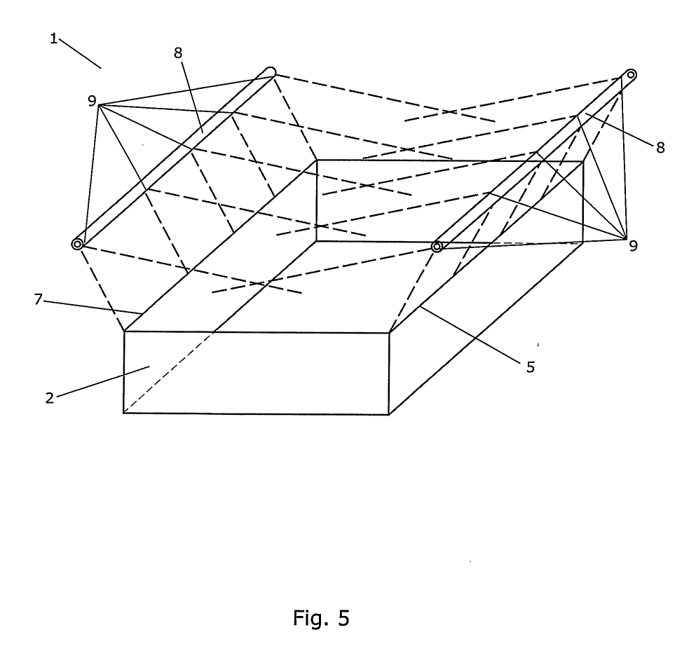

FIG. 5 is a perspective view of a cooking unit 1 having a fire protection system according to a second embodiment of the invention installed therein. The cooking unit 1 comprises a vessel 2 which contains liquid fat or grease, and which is open in an upwards direction. The cooking unit 1 is very similar to the cooking unit shown in FIG. 1. At a level above the vessel 2 two pipes 8 are arranged in such a manner that they extend in directions defined by the first rim 5 and the second rim 7, respectively, and outside boundaries defined by the rims 5, 7. Each of the pipes 8 comprises nozzles 9 directed towards the first rim 5 and towards the second rim 7.

As described above, in the case that the cooking unit comprises a conveyor (not shown) for carrying food products being cooked in the vessel 2, the conveyor being adapted to be submerged into/lifted from the vessel 2, the position of the pipes 8 shown in FIG. 5 ensures that fire suppressant can be directed towards the rims 5, 7 by means of the nozzles 9, even if the conveyor is in a lifted position. In this case the nozzles 6 shown in FIG. 1 would not be able to direct fire suppressant towards the rims 5, 7 because the conveyor would block the path. Thus, providing pipes 8 and nozzles 9 as shown in FIG. 5 would ensure that a fire in the vessel 2 can be extinguished, even if a conveyor is present in a lifted position.

It should be noted that the cooking unit 1 could be provided with the pipes 8 shown in FIG. 5 only, or it could be provided with the pipes 4 shown in FIG. 1 as well as the pipes 8 shown in FIG. 5.

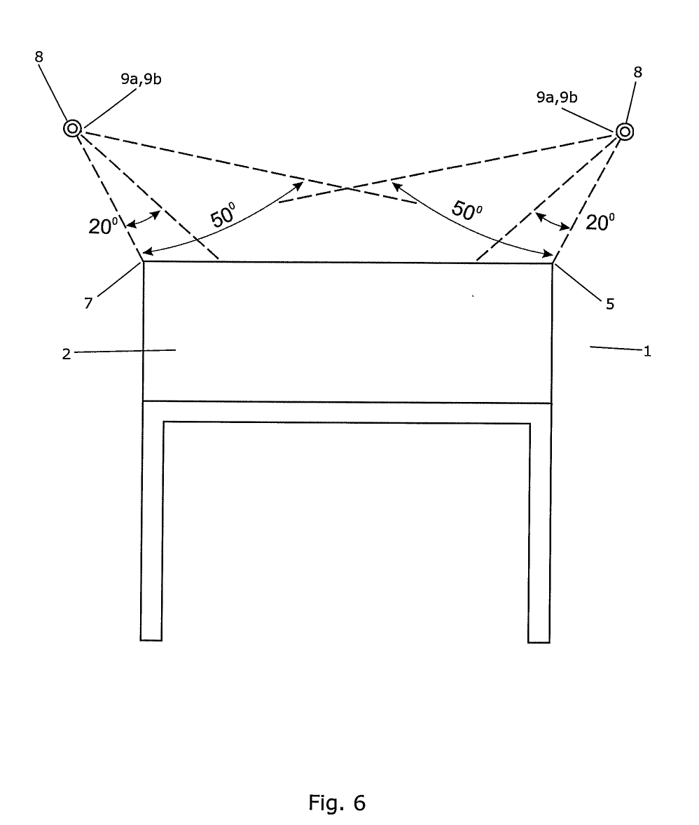

FIG. 6 is a side view of the cooking unit 1 of FIG. 5. It is clear from FIG. 6 that each of the pipes 8 comprises two sets of nozzles 9a, 9b. A first set of nozzles 9a is directed towards the first rim 5. Thus, the first set of nozzles 9a are the ones which at the pipe 8 shown at the right hand side of FIG. 5 are directed in a direction differing by 20° from the direction towards the first rim 5, and the ones which at the pipe 8 shown at the left hand side of FIG. 5 are directed in a direction differing by 50° from the direction towards the second rim 7. Similarly, a second set of nozzles 9b is directed towards the second rim 7. Thus, the second set of nozzles 9b are the ones which at the pipe 8 shown at the right hand side of FIG. 5 are directed in a direction differing by 50° from the direction towards the first rim 5, and the ones which at the pipe 8 shown at the left hand side of FIG. 5 are directed in a direction differing by 20° from the direction towards the second rim 7. The remarks set forth above with reference to FIG. 4 regarding the angles are equally applicable here.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A fire protection system for a cooking unit comprising a vessel containing liquid fat or grease, the fire protection system comprising:
a fire suppressant source comprising a propellant for propelling a water based fire suppressant from the fire suppressant source, and
at least one pipe being fluidly connected to the fire suppressant source in such a manner that fire suppressant from the fire suppressant source may be supplied to the pipe(s) by means of the propellant,
wherein at least one pipe is arranged above the vessel and extending along a direction defined by a first rim of the vessel, said pipe(s) comprising a first set of nozzles directed towards the first rim of the vessel, and a second set of nozzles directed towards a second rim of the vessel, said second rim being arranged opposite the first rim, said nozzles thereby being adapted to simultaneously spray fire suppressant supplied from the fire suppressant source towards said first and second rims.

2. The fire protection system according to claim 1, further comprising at least a second pipe being fluidly connected to the fire suppressant source in such a manner that fire suppressant from the fire suppressant source may be supplied to the second pipe by means of the propellant, said second pipe being arranged above the vessel and extending along a direction defined by the second rim of the vessel, said second pipe comprising a first set of nozzles being directed towards the first rim of the vessel and a second set of nozzles being directed towards the second rim of the vessel.

3. The fire protection system according to claim 1, wherein the pipe(s) is/are arranged in the interior of a hood arranged above the vessel.

4. The fire protection system according to claim 3, wherein the hood is movable along an at least substantially vertical direction between a lower extreme position and an upper extreme position, and wherein the first set of nozzles are directed towards the first rim of the vessel and the second set of nozzles are directed towards the second rim of the vessel when the hood is in the lower extreme position.

5. The fire protection system according claim 1, further comprising additional nozzles, said additional nozzles being arranged at a level above the vessel and outside boundaries defined by the first rim and the second rim, said additional nozzles being directed towards the first rim and/or towards the second rim.

6. The fire protection system according to claim 1, wherein the direction of the first set of nozzles and the direction of the second set of nozzles define an angle there between, said angle being within the interval 20° to 45°.

7. The fire protection system according to claim 1, wherein the nozzles are of a kind which generates mist of water based fire suppressant.

8. The fire protection system according to claim 1, wherein the nozzles belonging to the first set of nozzles are distributed at least substantially equidistantly along the direction defined by the first rim of the vessel.

9. The fire protection system according to claim 1, wherein the nozzles belonging to the second set of nozzles are distributed at least substantially equidistantly along the direction defined by the first rim of the vessel.

10. The fire protection system claim 1, wherein the nozzles belonging to the first set of nozzles have a flow capacity which differs from a flow capacity of nozzles belonging to the second set of nozzles.

11. The fire protection system according to claim 1, said fire protection system being automatically operable.

12. The fire protection system according to claim 11, further comprising one or more sensors adapted to detect one or more relevant fire parameters, the fire protection system being operable in response to one or more signals generated by the one or more sensors.

13. The fire protection system according to claim 1, wherein the propellant is or comprises a nitrogen propellant.

14. The fire protection system according claim 1, wherein the water based fire suppressant is water.

15. The fire protection system according to claim 1, wherein each of the nozzles of the fire protection system is subjected to at least substantially identical pressure of fire suppressant from the fire suppressant source.

16. A method of providing fire protection for a cooking unit comprising a vessel containing liquid fat or grease, the method comprising the steps of:
providing a fire suppressant source,
providing at least one pipe comprising a plurality of nozzles,
fluidly connecting the fire suppressant source and the at least one pipe,
propelling a water based fire suppressant from the fire suppressant source to each of the plurality of nozzles, via the at least one pipe, and
directing the nozzles in such a manner that a varying density of water based fire suppressant is obtained along an at least substantially transversal direction of the vessel.

17. The method according to claim 16, wherein the vessel comprises a first rim and a second rim, said rims defining boundaries of the vessel along the at least substantially transversal direction, and wherein the step of directing the nozzles is performed in such a manner that local maxima of the density distribution are obtained at or near the rims.

18. The method according to claim 17, wherein the step of directing the nozzles comprises directing a first set of nozzles towards the first rim and directing a second set of nozzles towards the second rim.
